(19) United States
(12) Patent Application Publication
(10) Pub. No.: US 2018/0030755 A1
(43) Pub. Date: Feb. 1, 2018

(54) MODULAR PROTECTION SYSTEM FOR CRITICAL ASSETS AND INFRASTRUCTURE

(71) Applicants: Gary Patterson, Lake Orion, MI (US); Tony Mcginnis, Lyon Township, MI (US)

(72) Inventors: Gary Patterson, Lake Orion, MI (US); Tony Mcginnis, Lyon Township, MI (US)

(21) Appl. No.: 15/714,577

(22) Filed: Sep. 25, 2017

Related U.S. Application Data
(63) Continuation-in-part of application No. 14/835,049, filed on Aug. 25, 2015.

(51) Int. Cl. E04H 17/16; F41H 5/24; E04H 9/10; E04H 17/20; E06B 11/04

(52) U.S. Cl. CPC E04H 17/168; E04H 17/20; E06B 11/045; E04H 9/10; F41H 5/24

(57) ABSTRACT

A modular system for protecting a critical asset includes a plurality of vertical members extending vertically upwardly from a ground surface, and inner and outer stacks of spaced-apart horizontal members connected between adjacent pairs of the vertical members defining a vertical wall. The spaced-apart horizontal members have cross sections and spacings such that no line can be drawn through the wall without intersecting with one or both of the inner and outer stacks. The cross sections of the horizontal members in both stacks include elongated angled surfaces such that projectile on a trajectory toward the critical asset is deflected upwardly or downwardly and away from the critical asset. In a preferred embodiment, the horizontal members are angle irons. In a more preferred embodiment the horizontal members are 1/2″ 90-degree steel angle irons oriented sideways, such that the elongated plates making up the angle irons are 45 degrees off horizontal.

### REFERENCE TO RELATED APPLICATIONS

This Application is a Continuation-in-Part of U.S. patent application Ser. No. 14/835,049, filed Aug. 25, 2015, the entire content of which is incorporated herein by reference.

### FIELD OF THE INVENTION

This invention relates generally to critical asset protection and, in particular, to a modular ballistic deflection barrier assembly.

### BACKGROUND OF THE INVENTION

Terrorist targets include any facility which, if damaged of compromised, would wreak chaos in some form. In addition to large buildings, bridges and dams, the list includes electrical transmission stations, transmission substations and their associated primary control centers. If rendered inoperable or damaged as a result of a physical attack, such an assault could result in widespread instability, uncontrolled separation, or cascading within an interconnection.” As such, the North American Electric Reliability Corporation (NERC) has instituted CIP-014-1, a program to identify and provide physical security for the physical protection of the bulk power systems. The proposed standard requires transmission owners to perform a risk assessment that identifies their critical transmission stations and substations, and their associated primary control centers. Once the critical facilities are identified, the proposed standard requires the owners to evaluate the physical threats and to develop and implement a security plan for these critical facilities.

The idea behind the requisite security system is to “deter, detect and delay.” There are many options for external detection including visible-light and thermal cameras, vibration detection, and radar. Proposed measures to deter include the construction of hardened perimeters around entire sites to erecting walls around specific equipment. Some mitigation strategies involve constructing partial screens to mask the location of critical equipment. Protection against larger ballistic projectiles presents particular challenges. Large solid structures are inflexible, expensive and likely not conducive to aesthetic decoration. Lighter weight structures, on the other hand, may not be effective.

Ballistic resistant wall panel enclosures have been designed to prevent damage from projectiles. Such enclosures utilize fiberglass reinforced panels in conjunction with perimeter fencing. The Ballisti-Wall and Ballisti-Cover from Sensei Solutions LLC of Holly Ridge, NC are lightweight, corrosion proof, non-conductive, and electromagnetically transparent products that can be customized and implemented to protect critical substation assets. Constructed from multiple layers of woven fiberglass encapsulated with a proprietary resin system that produces a rigid panel with exceptional ballistic resistance, the unique composite matrix of the panels allow for the retention of the projectile to avoid potentially hazardous ricochet.

The Intelli-Firewall manufactured by Composite Support & Solutions Inc. of San Pedro, Calif. has been installed by large utilities to protect transformers in major substations in California. The product features a ceramic composite material that is manufactured using a ‘green’ process technology. The modular design uses light weight [320 lb] panels that facilitate handling and installation. The system is designed to minimize load bearing impact at the base of the wall using steel columns, casings and other components that allow for rapid removal and reassembly to optimize flexibility.

### SUMMARY OF THE INVENTION

This invention resides in a modular system for protecting a critical asset on a ground surface. The system comprises a plurality of vertical members extending vertically upwardly from a ground surface, and inner and outer stacks of spaced-apart horizontal members connected between adjacent pairs of the vertical members defining a vertical wall.

The spaced-apart horizontal members have cross sections and spacings such that no line can be drawn through the wall without intersecting with one or both of the inner and outer stacks. The cross sections of the horizontal members in both stacks include elongated angled surfaces such that projectile on a trajectory toward the critical asset is deflected upwardly or downwardly and away from the critical asset.

In a preferred embodiment, the horizontal members are angle irons. In a more preferred embodiment the horizontal members are ½″ 90-degree steel angle irons oriented sideways, such that the elongated plates making up the angle irons are 45 degrees off horizontal.

### BRIEF DESCRIPTION OF THE DRAWINGS

FIG. 1 is a simplified schematic diagram illustrating a modular ballistic deflection barrier assembly configured in accordance with the invention;

FIG. 2 is a top view showing I-beam vertical members and filed plate that connect to the horizontal deflection members;

FIG. 3 shows the way in which V-shaped horizontal members connect to vertical I-beams;

FIG. 4 illustrates a section at the vertical supports;

FIG. 5 illustrates a section at elevation with a non-limiting set of dimensions;

FIG. 6 depicts and alternative arrangement of horizontal members and connections associated therewith;

FIG. 7A illustrates alternative construction technique wherein separate ballistic panels are slid into place;

FIG. 7B is a drawing in partial cross section depicting details of the alternative construction technique of FIG. 7A; and

FIG. 8 shows a preferred sliding gate structure.

### DETAILED DESCRIPTION OF THE INVENTION

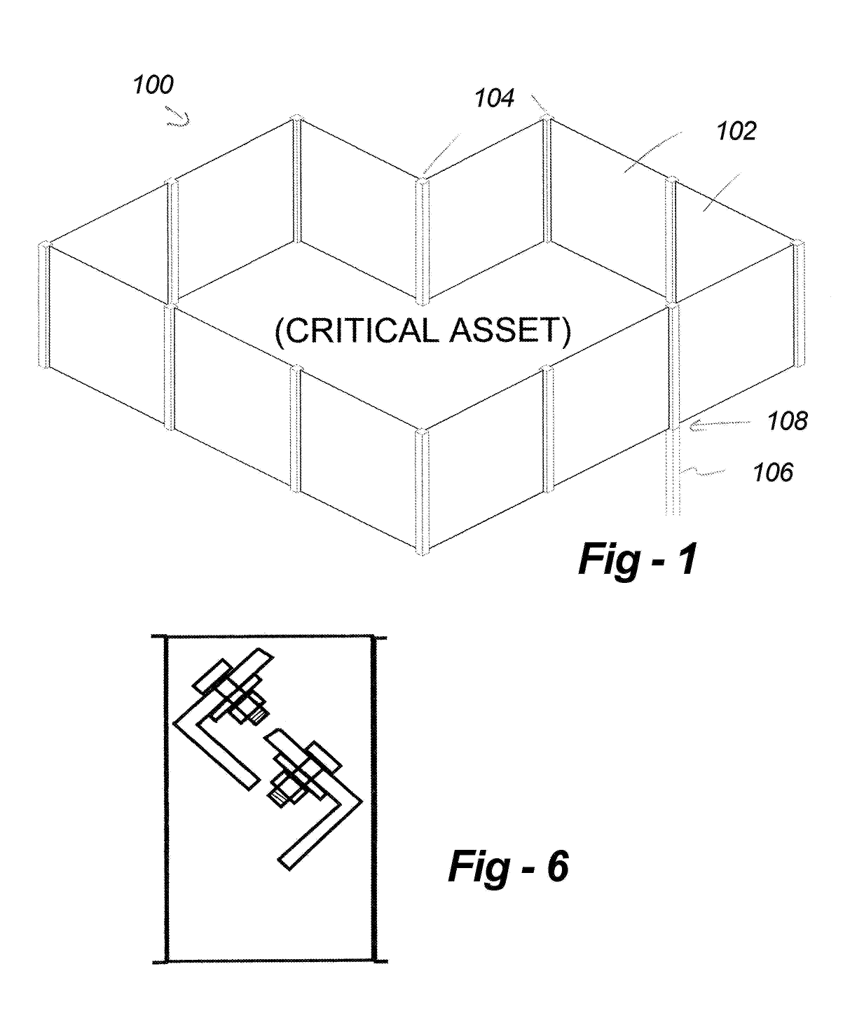

FIG. 1 is a simplified schematic diagram illustrating a modular ballistic deflection barrier assembly 100 configured in accordance with the invention. The system broadly comprises a plurality of upright vertical members 104 an generally vertical walls 102 supported between adjacent pairs of the members 104. The critical asset, which may be an electrical transmission station, transmission substation, control center, building or any other form of infrastructural unit, is shown entirely surrounded by the inventive barrier 100; however, being modular in nature, the barrier 100 may be configured to partially surround an asset or any other appropriate arrangement.

In the preferred embodiment, as described in detail herein, the vertical upright members are steel I-beams and the walls 102 are constructed from inner and outer stacks of spaced-apart horizontal members. Thus, the walls are not “solid” as inferred by FIG. 1, but instead resemble “louvers” which allow air to pass therethrough while deflecting and blocking ballistic penetration. As schematically illustrated in FIG. 1, the corner and support posts are preferably buried several feet at 106 below a ground surface 108. In the preferred embodiment the vertical members are on the order of 10 feet apart, though the invention is not limited in this respect. The walls may be of any height depending upon the asset to be protected.

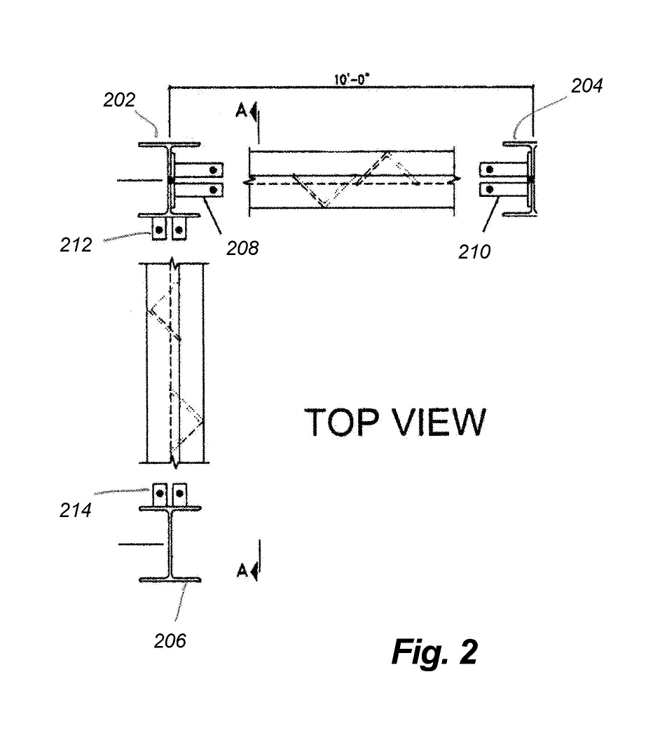

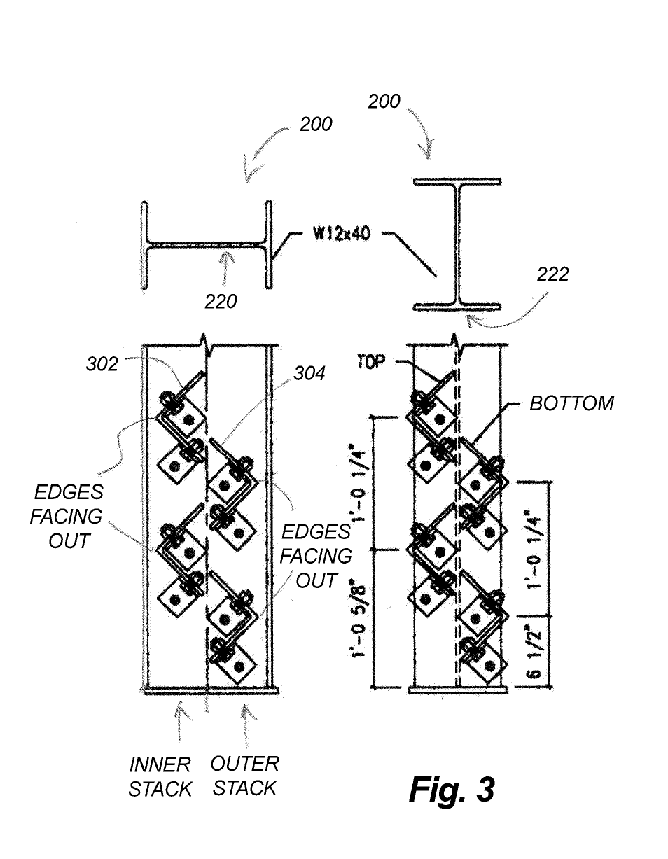

FIG. 2 is a top view showing the I-beam vertical members 202. 204, 206 and field plates 208, 210, 212, 214 that connect to the horizontal deflection members. FIG. 3 shows the way in which V-shaped horizontal members 302, 304 connect to vertical I-beams 200 through the field plates. As can be seen, the preferred assembly includes inner and outer stacks of spaced-apart horizontal members connected between adjacent pairs of the vertical members to define each vertical wall. The drawing on the left shows how the horizontal members attach to an inner surface 220 of a vertical I-beam, and the drawing on the right shows how the horizontal members attach to an outer surface 222 of the vertical I-beam. The spaced-apart horizontal members have cross sections and spacings such that no line can be drawn through the wall without intersecting with one or both of the inner and outer stacks.

The cross sections of the horizontal members in both stacks include elongated angled surfaces such that projectile on a trajectory toward the critical asset is deflected upwardly or downwardly and away from the critical asset. In the preferred embodiment, the horizontal members are ½″ steel angle irons, though other stock with different thicknesses may alternatively be used. Such angle irons comprise two strips of metal intersecting at an angle defining a V-shaped cross section and an elongated common edge. In the preferred embodiment, the common edges of the horizontal members in both of the stacks are oriented outwardly away from the wall. In the preferred embodiment, 90-degree angle irons are used sideways, such that the angles of the plates making up the I-beams are substantially 45 degrees from horizontal.

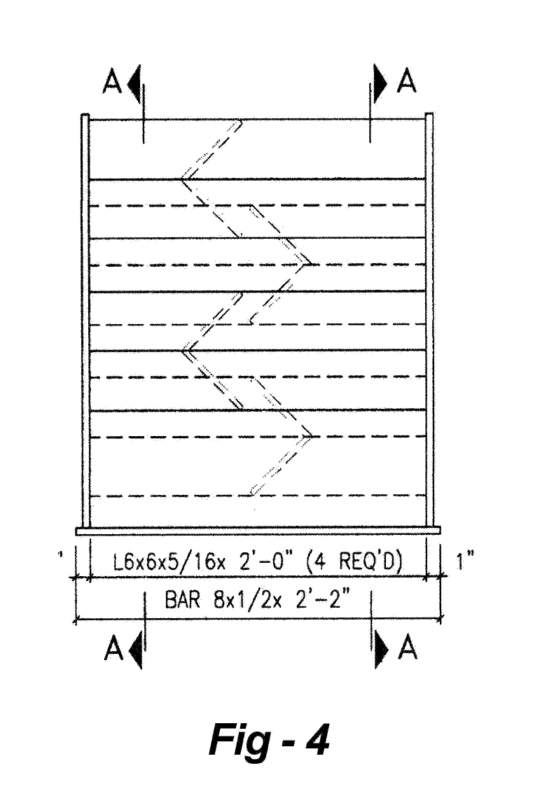

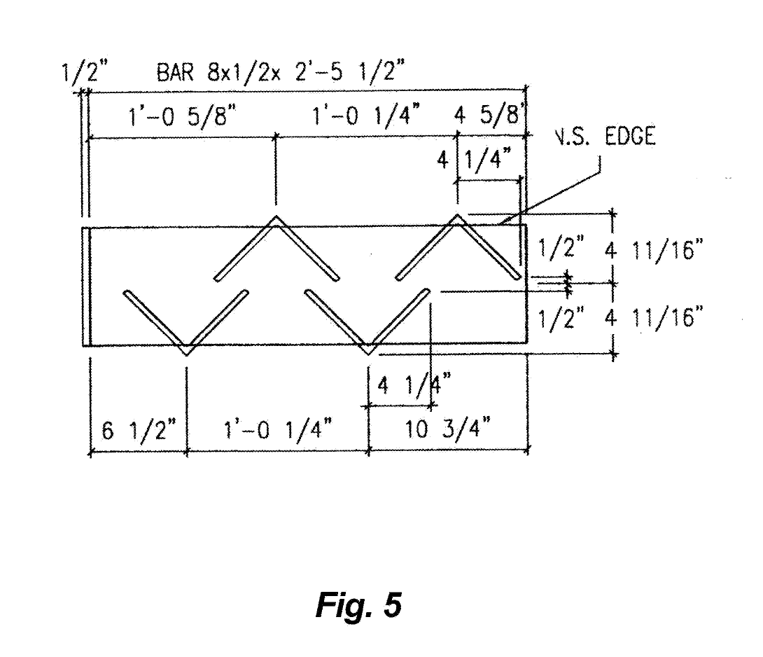

FIG. 4 illustrates a section at the vertical supports, and FIG. 5 illustrates a section at elevation with a non-limiting set of dimensions. FIG. 6 depicts and alternative arrangement of horizontal members and connections associated therewith.

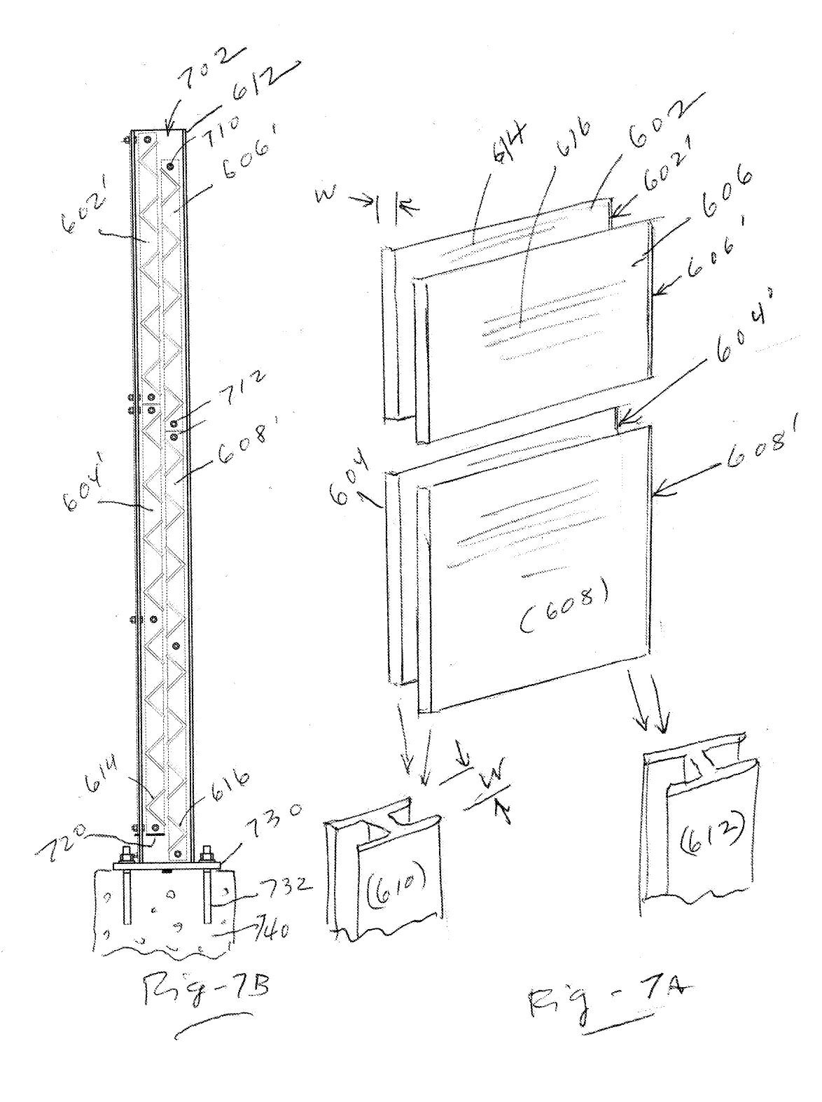

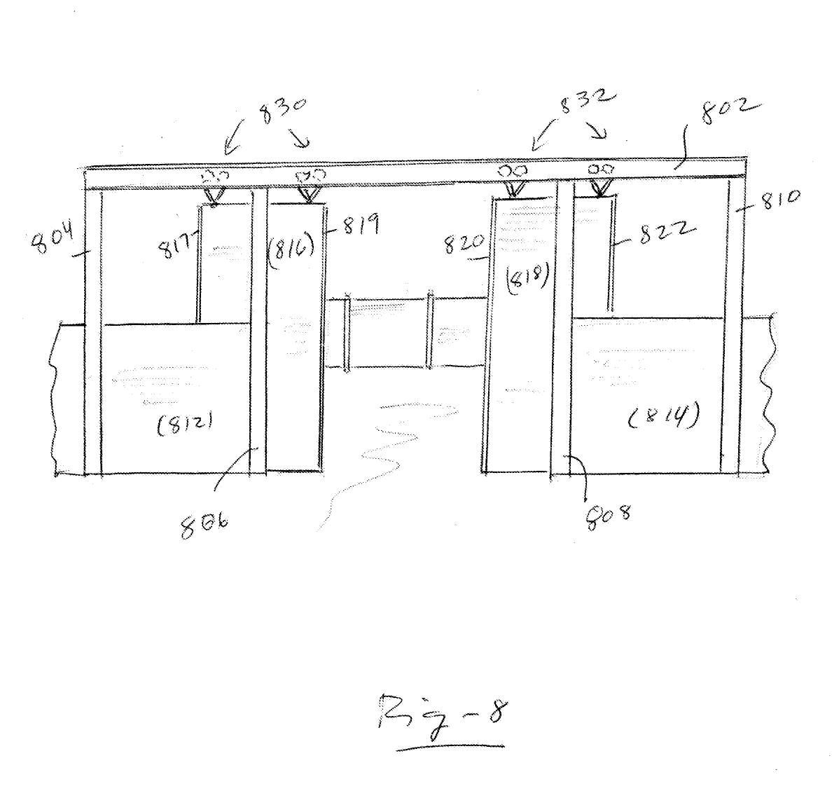

FIGS. 7A, 7B illustrate alternative construction techniques. In particular, as depicted in FIG. 7A, separate ballistic panels 602, 604, 606, 608 may be constructed separately from the vertical members 610, 612 and slid into place. In the preferred embodiment, the vertical members are I-beams with channels having a width “W,” and the panels each have a width “w” less than ½ W enabling two of the panels to be loaded into the channels as shown in the partial cross section of FIG. 7B. This construction allows the horizontal V-shaped members 614, 616 to be welded or otherwise connected to side members such as 602′, 604′, 606′ and 608′. In addition, though not necessary, multiple panels (such as 606 and 608) may be stacked on top of one another in each channel to ease construction and/or reduce panel weight.

FIG. 7B is a drawing in partial cross section that shows panels 602, 604, 606, 608 received within the channel 702 of I-beam 612. This drawing also illustrates side panels 602′, 604′, 606′ and 608′ to which the horizontal members 614, 616 are joined. The side panels may alternatively be joined as by bolts 710, 712, etc., to the I beams or left “floating.” Note that one or more stop(s) 720 may be used such that when the panels are slid into place, the horizontal members 614, 616 are properly aligned as shown. FIG. 7B also shows how a bottom plate 730 may be used with bolts 732 into a concrete footing 740 for anchoring purposes.

FIG. 8 illustrates a preferred gate construction. I this embodiment, a horizontal member 802 such as an I-beam or other angle iron is supported above wall sections 812, 814 by vertical members 804, 806, 808, 810. Doors 816, 818 are suspended from the member 802 via rollers 830, 832, enabling the doors to open and close. Doors 816, 818 are constructed similarly to wall sections with horizontal ballistic-protection members being fastened to end members 817, 819 and 820, 822, respectively. In the preferred construction, inner and outer sets of horizontal members are welded between the side members 817, 819 and 820, 822, respectively, to provide the cross sectional appearance shown in FIG. 7B, for example. The doors may slide in lower tracks (not shown), and when closed, vertical members 819, 820 abut one another and may be locked with any suitable high-security locking mechanism.

1. A system for protecting a critical asset on a ground surface, comprising:
a plurality of vertical members extending vertically upwardly from the ground surface;
inner and outer stacks of spaced-apart horizontal members connected between adjacent pairs of the vertical members defining a vertical wall;
wherein the spaced-apart horizontal members have cross sections and spacings such that no line can be drawn through the wall without intersecting with one or both of the inner and outer stacks;
wherein the cross sections of the horizontal members in both stacks include elongated angled surfaces such that projectile on a trajectory toward the critical asset is deflected upwardly or downwardly and away from the critical asset;
a gate disposed between two of the vertical members facilitating access to the critical asset; and
wherein the vertical walls and gate entirely surround the vertical asset providing ballistic protection from any direction around the critical asset.

2. The system of claim 1, wherein the horizontal members are angle irons.

3. The system of claim 1, wherein the horizontal members are angle irons having a thickness in the range of from ¼ to 1 inch.

4. The system of claim 1, wherein the horizontal members are angle irons having a thickness of substantially ½ inch.

5. The system of claim 1, wherein:
the horizontal members comprise two strips of metal intersecting at an angle defining a V-shaped cross section and an elongated common edge; and
wherein the common edges of the horizontal members in both of the stacks are oriented outwardly away from the wall.

6. The system of claim 5, wherein the horizontal members are 90 degree angle irons oriented sideways, such that the strips of metal making up the angle irons are 45 degrees off horizontal.

7. The system of claim 1, wherein:
the vertical members are I-beams having opposing elongated channels; and
the inner and outer stacks of spaced-apart horizontal members are formed as separate panels that slide into the opposing elongated channels of the I-beams.

8. The system of claim 7, wherein:
the inner stacks of spaced-apart horizontal members are formed as inner panels;
the outer stacks of spaced-apart horizontal members are formed as outer panels; and
the inner and outer panels are positioned face-to-face in the elongated channels of the I-beams.

9. The system of claim 7, wherein:
the inner stacks of spaced-apart horizontal members are formed as inner panels having a width “w”;
the outer stacks of spaced-apart horizontal members are formed as outer panels also having a width “w”; and
the elongated channels of the I-beams have a width of at least 2w to receive the inner and outer panels in a face-to-face configuration.

10. The system of claim 7, including separate panels that are stacked on top of one another.

11. The system of claim 1, wherein:
the gate is constructed with a horizontal member spanning at least two of the vertical members; and
one or more sliding ballistic panels suspended from the horizontal member.
